(19) United States
(12) Patent Application Publication
(10) Pub. No.: US 2014/0087144 A1
(43) Pub. Date: Mar. 27, 2014

(54) RESIN MOLDED PRODUCT

(71) Applicant: NIHON PLAST CO., LTD., Fujinomiya-shi (JP)

(72) Inventors: Kazuyuki ENDO, Fuji-shi (JP); Masayuki SEKINE, Fujinomiya-shi (JP)

(73) Assignee: NIHON PLAST CO., LTD., Fujinomiya-shi (JP)

(21) Appl. No.: 14/038,005

(22) Filed: Sep. 26, 2013

(30) Foreign Application Priority Data
Sep. 27, 2012 (JP) 2012-214195

(51) Int. Cl. B32B 3/28

(52) U.S. Cl. CPC B32B 3/28
USPC 428/174

(57) ABSTRACT

A curved resin molded product. The resin molded product is provided to include: a pair of resin films defining first and second main surfaces, the first and second main surfaces being different in curvature from each other; and a resin base member disposed between the resin films. In the resin molded product, one of the resin films, which is on the side of a relatively larger curvature of the first and second main surfaces, has a thermal shrinkage larger than that of the other of the resin films which is on the side of a relatively smaller curvature.

### BACKGROUND OF THE INVENTION

The present invention relates to a resin molded product which is molded by filling a molten resin into between a pair of resin films.

As a conventional transparent resin glass, there has been reported a transparent polycarbonate resin on which a silicon-based (or derived from a SiO₂ solution) or acrylic hard coat is formed by dip coating, flow coating, spray coating or the like in order to improve scratch resistance and abrasion resistance (see Patent Publications 1 to 3).

However, such a technique is not easy to control at the time of coating. Additionally, the technique is not easy to stably control when applied to a molded article having a curvature such as a window of an automotive vehicle since heat treatment (e.g., anneal treatment and drying process on a molded article) is involved therein. More specifically, the thus treated window encounters dispersion of stress when installed in the vehicle thereby sometimes being affected in terms of its material properties and viewability. Thus, this technique is not reasonable to adopt.

In addition, since a molding process and a surface treatment to be performed are extraneous to each other, the processing cycle and the production efficiency are not satisfying. Moreover, the above-mentioned resin glass is inferior to a tempered glass in cost, so that it cannot be said to widely penetrate the market.

Meanwhile, there is also reported a technique of molding a resin glass by insert molding in the use of a resin film (see Patent Publications 4 to 6).

In Patent Publications 4 and 5, the so-called double insert molding technique is disclosed; where thermoplastic resin films having one principal surface coated with a cured film are disposed on both sides of a cavity of an injection mold such that the one principal surface is disposed outermost after molding, upon which a double-sided integrally laminated film is molded.

Furthermore, Patent Publication 6 is directed to a film insert molding technique that uses a highly rigid and highly transparent resin composition prepared by blending polycarbonate that serves as a base member, a glass filler having a refractive index smaller than that of the aromatic polycarbonate resin by 0.015 or less and polycaprolatone to one another thereby improving flexural modulus and suppressing a molding deformation of a molded product having a curvature.

In these structures, it is preferable that a resin film is a resinous material well compatible with a resin base member. By using such a resinous material, a resin film layer is to function as a heat insulator at the time of molding, and additionally the resin is not rapidly cured even when cooled on the surface of a mold so as to be reduced in flow resistance, with which flow marks and silver streaks are hard to occur and a low-distortion molding becomes feasible.

Furthermore, as the reflection property of the resin glass is determined according to the surface properties of the resin film, it is not necessary to subject a mold to a mirror polishing as the case of applying a hard coat, so that the production cost can be saved.

Thus, a coating process is not required and therefore the processing cycle and the production efficiency are greatly improved as compared with the structure where a hard coat is applied. Additionally, if the resin film is improved in surface properties (such as scratch resistance and abrasion resistance) to the same extent as the case of applying a hard coat, cost will also be advantageously saved.

### REFERENCES ABOUT PRIOR ART

### Patent Publication

Patent Publication 1: Japanese Patent Application Publication No. 48-81928, pp. 2-4

Patent Publication 2: Japanese Patent Application Publication No. 52-138565, pp. 2-4

Patent Publication 3: Japanese Patent Application Publication No. 53-138476, pp. 3-6

Patent Publication 4: Japanese Patent Application Publication No. H03114718, pp. 2-3 and FIGS. 1 and 2

Patent Publication 5: Japanese Patent Application Publication No. 8-187748, pp. 3-5 and FIGS. 1 and 3

Patent Publication 6: Japanese Patent Application Publication No. 9-164552, pp. 3-6 and FIG. 1

Patent Publication 7: U.S. Pat. No. 5,733,659

### SUMMARY OF THE INVENTION

When a flat molded article is intended to be produced by insert molding that uses a resin film as mentioned above, stress applied on the interface between each resin film of front and back sides and a resin base member is generally even thereby providing a molded article which has less residual strain and stable. However, most of the recent automotive vehicles are provided to have a bodywork composed of curved parts in order to reduce air resistance and meet designedness, and therefore its window glass is also provided to have a curved surface. In the case of using a curved molded article as the above-mentioned resin glass for vehicle window, there occurs a difference of elongation between the obverse-side resin film and the back-side resin film. Hence, when a molten resin is cured, a difference of stress is brought about between the obverse and back sides of the molded article so as to cause residual strain. It is therefore desired not to generate defects resulted from the residual strain, such as unstable curvature and reduction of viewability.

In view of the above, an object of the present invention is to provide a resin molded product which is excellent in productivity and suppresses residual strain.

An aspect of the present invention resides in a curved resin molded product comprising: a pair of resin films defining first and second main surfaces, the first and second main surfaces being different in curvature from each other; and a resin base member disposed between the resin films, wherein one of the resin films, which is on the side of a relatively larger curvature of the first and second main surfaces, has a thermal shrinkage larger than that of the other of the resin films which is on the side of a relatively smaller curvature.

### EFFECTS OF THE INVENTION

According to the resin molded product according to the present invention, one of the resin films, which is on the side of a relatively larger curvature of the first and second main surfaces, is provided to have a thermal shrinkage larger than that of the other of the resin films which is on the side of a relatively smaller curvature. With this, stresses generated in the way of curing the molten resin and acting on interfaces between the cured molten resin and each of the resin films and on the resin films are equalized by the thermal shrinkage difference between the resin films, thereby allowing easily obtaining a resin molded product excellent in productivity and prevented from residual strain.

### BRIEF DESCRIPTION OF THE DRAWINGS

FIG. 1 is an exploded perspective view of an embodiment of a resin molded product according to the present invention;

FIG. 2 is a perspective view of the resin molded product;

FIG. 3 is a cross section of the resin molded product;

FIG. 4 is a table indicating examples of resinous material used for a base member of the resin molded product;

FIG. 5A is a table showing thermal shrinkage ratios of a resinous material formed of polycarbonate;

FIG. 5B is a table showing thermal shrinkage ratios of a resinous material formed of acrylic resin; and

FIGS. 6A to 6C are explanatory views showing a method for producing the resin molded product in this order.

### DETAILED DESCRIPTION OF THE INVENTION

Referring now to the accompanying drawings, an embodiment of a resin molded product according to the present invention will be discussed.

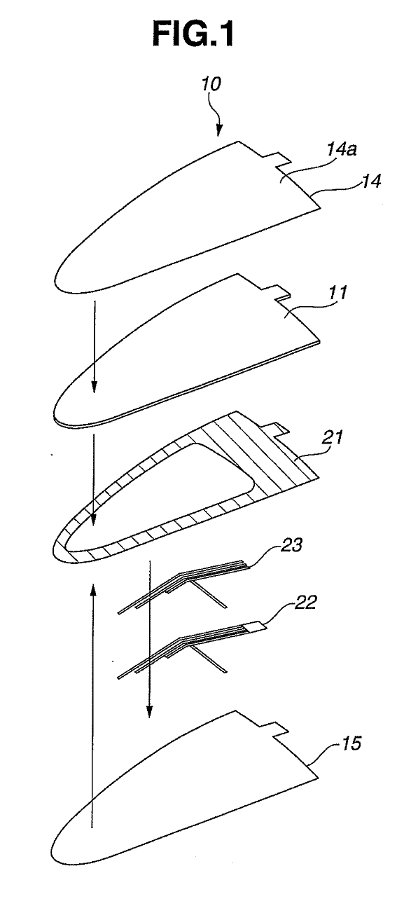

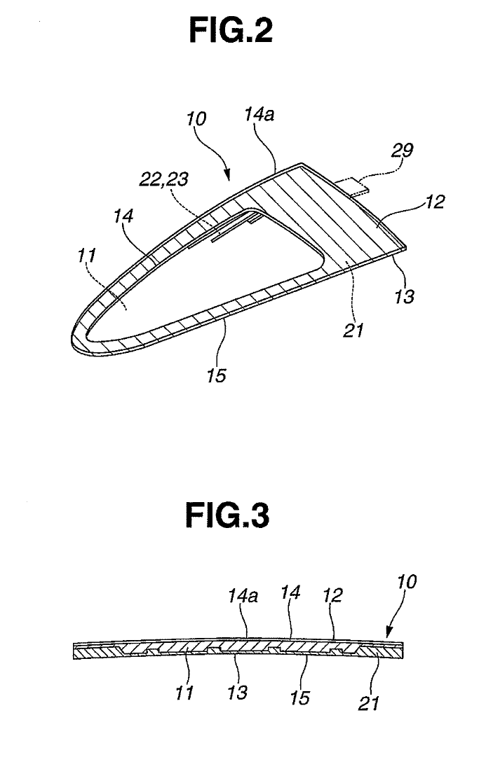

In FIGS. 1 to 3, a resin molded product is illustrated by reference numeral 10. The resin molded product 10 may be an automotive vehicle window, for example (in the embodiment of the present invention, it is an automotive component used for a rear quarter window), and it is provided to integrally include a base member 11 and resin films 14 and 15 which cover one principal surface and the other principal surface of the base member 11 entirely so as to provide the resin molded product 10 with a front surface (or outer surface) 12 and a back surface (or inner surface) 13, the front and back surfaces 12 and 13 being serve as first and second main surfaces of the resin molded product 10, respectively. The resin molded product 10 is shaped longitudinal in a travelling direction of automotive vehicle and curved to have different curvatures between longitudinal direction and width direction (vertical direction of the automotive vehicle). In the embodiment of the present invention, the resin molded product 10 is formed such that the curvature of the front surface 12 is smaller than that of the back surface 13. More specifically, the resin molded product 10 is shaped projected in a direction from the back surface 13 toward the front surface 12. In other words, in the resin molded product 10, the front surface 12 serves as a projected side while the back surface 13 serves as a depressed side.

The base member 11 is formed of a resinous material which is a thermoplastic synthetic resin having transparency (translucency) such as polycarbonate. Additionally, the base member 11 forms a generally triangular shape, the width of which is gradually decreased from one end of the longitudinal direction toward the other end.

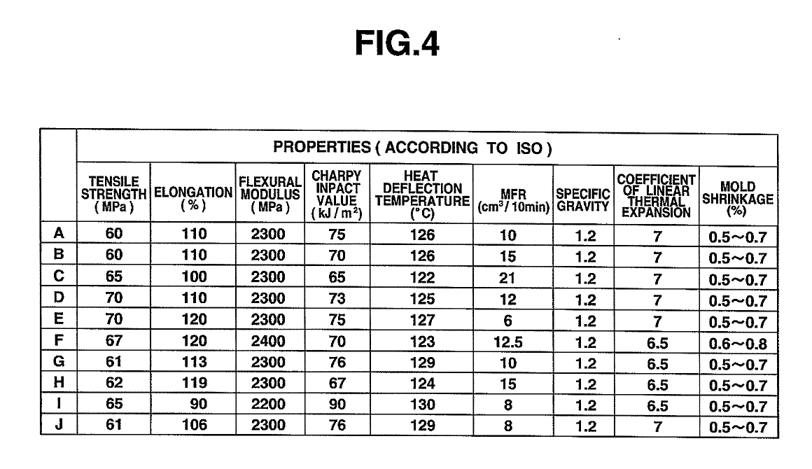

As examples of the resinous material used for the base member 11, it is possible to cite materials A to J, the material properties of which are shown in FIG. 4. More specifically, as the resinous material that constitutes the base member 11, it is possible to use those generally having a tensile strength of 60 to 70 Mpa, elongation of 90 to 120%, a flexural modulus of 2200 to 2400 Mpa, a Charpy impact value of 65 to 90 kJ/m², a heat deflection temperature of 122 to 130° C., a melt flow rate of 6 to 21 cm³/10 min, a specific gravity of 1.2, a coefficient of linear thermal expansion of 6.5 to 7 and a mold shrinkage of 0.5 to 0.8%. Among these physical properties, the Charpy impact value and the melt flow rate are particularly important for the resin molded product 10 used in window. It is more preferable that the Charpy impact value is within a range of 65 to 80 kJ/m² and the melt flow rate is within a range of 6 to 20 cm³/10 min.

Furthermore, the resin film 14 that is to constitute the side of the front surface 12 is also referred to as a hard coat film and behaves as a design surface of the resin molded product 10. The resin film 14 is preferably a film having high impact resistance and transparency, such as a polycarbonate (PC) film, and it is more preferable that a surface 14a (outer surface that the resin film 14 has on the side not facing the base member 11) of the resin film 14 is coated with a scratch-resistant cured film such as a silicon-based hard coat, an acrylic hard coat and the like. Additionally, the resin film 14 has a thickness of 50 to 1000 μm, preferably 125 to 500 μm from the viewpoint of moldability and cost.

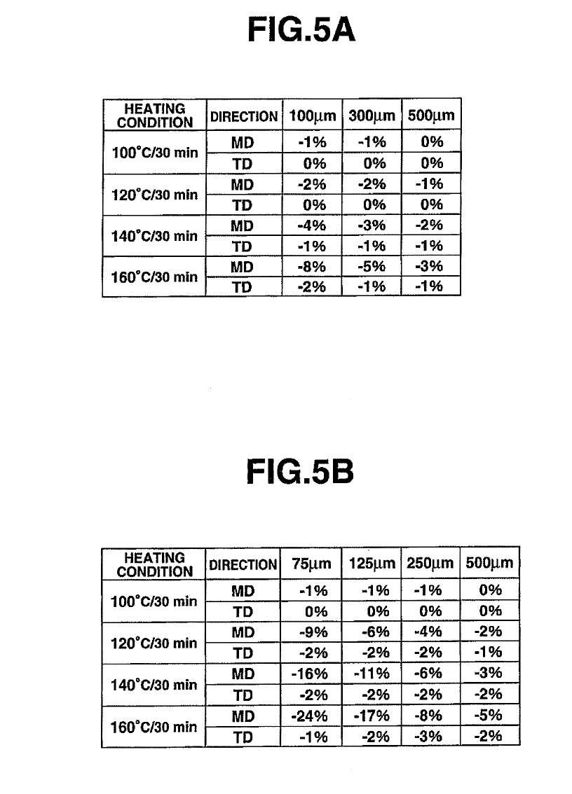

On the other hand, the resin film 15 that is to constitute the side of the back surface 13 is formed of: a resin film the material of which is the same as the resin film 14 constituting the side of the front surface 12 and thinner than the resin film 14; or a resin film the material of which is different from that of the resin film 14 constituting the side of the front surface 12 and higher in thermal shrinkage than the resin film 14. If comparisons are made among the thermal shrinkage ratios of a polycarbonate resin film (the resin film 14) shown in FIG. 5A and those of an acrylic resin film (the resin film 15) shown in FIG. 5B, it can be found that the acrylic resin film has larger thermal shrinkage ratios particularly under high heating temperature conditions. In FIGS. 5A and 5B, “TD” means a transverse direction in which a resin flows and “MD” means a machine direction (a width direction) perpendicular to the transverse direction. Moreover, the smaller the thickness of these resin films is, the greater its thermal shrinkage becomes even if these resin films are formed of the same material. In the embodiment of the present invention, therefore, a polycarbonate film having a thickness of 500 μm is used as the resin film 14 and a film formed of acrylic resin or polymethylmethacrylate (PMMA) and having a thickness of 125 μm is used as the resin film 15 so that the thermal shrinkage of the resin film 15 is larger than that of the resin film 14. More specifically, the resin film 14 constituting the side of the front surface 12 and the resin film 15 constituting the side of the back surface 13 are provided so that the difference between their thermal shrinkages under a heating condition of 160° C./30 min is 2 to 15% in the width direction (MD) (so that the thermal shrinkage of the resin film 15 is 2 to 15% greater than that of the resin film 14 in the width direction (MD) under a heating condition of 160° C./30 min).

Incidentally, as the resin film 15, it is also possible to use a film having a certain functional layer as needed or a film coated with a cured film similarly to the resin film 14 according to desired performances.

In the embodiment of the present invention, the resin film 15 is provided to have a certain functional layer, and more specifically, various function layers such as a black framed print 21 covering outer peripheral edge portion of the resin film 15, an antenna print 22 and an antenna resist layer 23 that covers the antenna print 22.

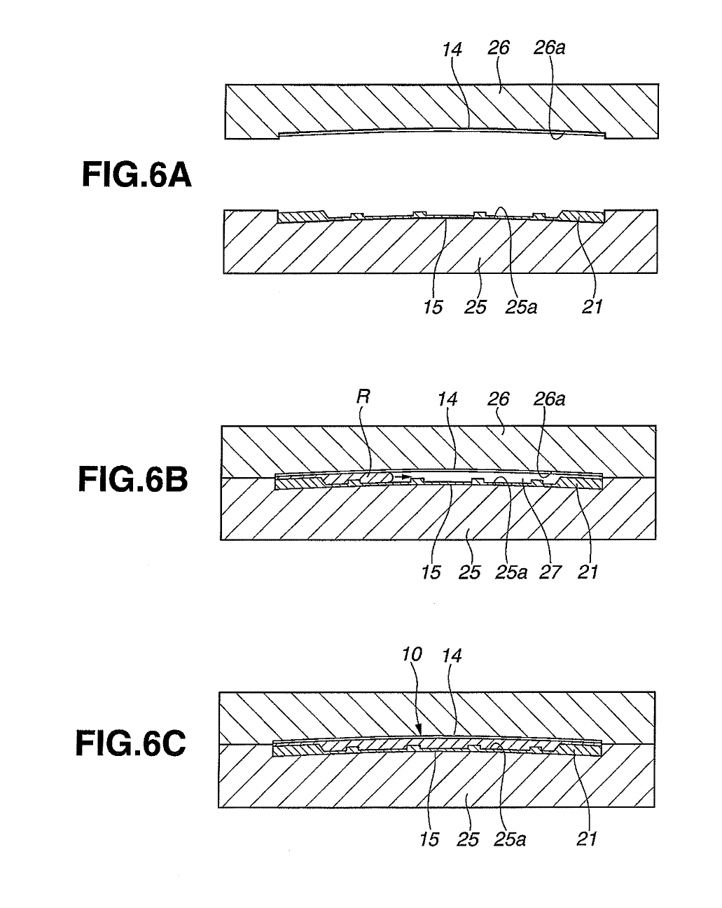

Then, the resin molded product 10 is integrally molded between a first mold 25 and a second mold 26 as shown in FIGS. 6A to 6C (double film insert molding).

The first mold 25 is also referred to as a core and defines a space or cavity 27 to be filled with a molten resin “R” constituting the base member 11, in cooperation with the second mold 26. More specifically, the first mold 25 has a first cavity surface 25a at the portion opposed to the second mold 26, the first cavity surface 25a serving as a first cavity-defining surface for defining the cavity 27. The first cavity surface 25a has a curved shape gradually upwardly projected from an outer edge portion toward around a central portion, on which the resin film 15 is fixed at the time of molding the resin molded product 10.

The second mold 26 is also referred to as a cavity and has a second cavity surface 26a at the portion opposed to the first mold 25, the second cavity surface 26a being opposed to the first mold 25 to serve as a second cavity-defining surface for defining the cavity 27 between the second cavity surface 26a and the first cavity surface 25a of the first mold 25. The second cavity surface 26a has a curved shape gradually upwardly depressed from an outer edge portion toward around a central portion, on which the resin film 14 is fixed at the time of molding the resin molded product 10.

In order to produce the resin molded product 10, the resin film 15 is initially fixed on the first cavity surface 25a of the first mold 25 as shown in FIG. 6A, the resin film 15 having previously been provided with the black framed print 21, the antenna print 22 and the antenna resist layer 23 covering the antenna print 22. On the other hand, the resin film 14 is fixed on the second cavity surface 26a of the second mold 26.

Then, the first and second molds 25 and 26 are matched to each other (“clamping”) to define the cavity 27 as show in FIG. 6B, and the molten resin “R” is injected into the cavity 27 to fill it by an injection mechanism (though not shown). Incidentally, a gate through which the molten resin “R” is injected into the cavity 27 is to be disposed at a projecting portion 29 that is formed to project outwardly from the final configuration of the resin molded product 10 as indicated by a phantom line, the projecting portion 29 being cut off after molding.

Thereafter the molten resin “R” is cooled by a cooling mechanism (not shown) to be cured as shown in FIG. 6C, followed by separating the first mold 25 and the second mold 26 (“mold opening”) to release the resin molded product 10 therefrom, thereby obtaining the resin molded product 10 where both sides of the base member 11 are covered with the resin films 14 and 15.

In general, when a curved resin molded product having a curvature is produced by double film insert molding, a difference of elongation is caused between a front or outer-side resin film and a back or inner-side resin film. With this, there occurs a stress difference between interfaces formed between each resin film and a base member when a molten resin is cured, which results in unfavorable increase of residual strain. In other words, when the same resin film is used on front and back sides of a curved resin molded product, the front-side resin film having a relatively low curvature exhibits an elongation greater than the back-side resin film having a relatively high curvature; therefore if the thermal shrinkage of the both resin films is equal the front-side one becomes superior to the back-side one in residual strain caused after molding in the way of curing the base member, which easily results in an inward warp of the resin molded product and the dispersion of curvature.

In view of the above, the embodiment of the present invention is arranged such that the thermal shrinkage of the resin film 15 which constitutes the side of the back surface 13 having a relatively high curvature is greater than that of the resin film 14 which constitutes the side of the front surface 12 having a relatively low curvature. With this, stresses acting on interfaces between the base member 11 and each of the resin films 14 and 15 and on the resin films 14 and 15 (the stresses are generated in the way of curing the molten resin “R” by an elongation difference caused between the resin films 14 and 15 at the front and back surfaces 12 and 13 in the first and second molds 25 and 26) are equalized by the thermal shrinkage difference between the resin films 14 and 15, thereby allowing obtaining the resin molded product 10 having little residual strain and high dimensional stability at low cost even if the resin molded product 10 has a curved shape, just as in the case of producing a flat resin molded product.

Since the molding process is identical to that of the conventional double film insert molding, the resin molded product 10 which is excellent in productivity, prevented from residual strain, and prevented from viewability reduction and deflection (such as inward warp) derived form the residual strain, can be favorably obtained.

Additionally, it is also possible to make the thermal shrinkage of the resin film 15 greater that that of the resin film 14 by providing the resin film 15 with a thickness smaller than that of the resin film 14 (or suitably changing the thickness of the resin films 14 and 15).

Additionally, it is also possible to make the thermal shrinkage of the resin film 15 greater that that of the resin film 14 by selecting for the resin film 15 a material having a thermal shrinkage greater than the material for the resin film 14 has.

Moreover, the gate through which, the molten resin “R” is injected into the cavity 27 at the time of molding the resin molded product 10 is provided disposed at the projecting portion 29 that will finally be cut off; therefore, it becomes possible to feed the molten resin “R” uniformly all over the resin molded product 10, with which the occurrence of flow marks and the like is suppressed and therefore the resin molded product 10 is excellently finished.

In the above embodiment of the present invention, the resin molded product 10 may be arranged such that the curvature of the side of the front surface 12 is larger than that of the side of the back surface 13. In this case, effects to the same extent as in the above embodiment are obtained if the resin film 14 constituting the side of the front surface 12 has a greater thermal shrinkage than the resin film 15 constituting the side of the back surface 13 has.

Though the material or thickness of the resin films 14 and 15 may be changed in order to bring about a difference of a thermal shrinkage between the resin films 14 and 15, it is also effective to change the temperature of the molds 25 and 26.

The resin molded product may be produced by a forming process other than injection molding, by thermo forming for example. More specifically, a large thin resin plate obtained by T-die extrusion may be laminated at both upper and lower surfaces with resin films which have thermal shrinkages different to each other. Then the resin plate is cut out to a certain smaller flat plate shape and then provided with a certain curved shape by thermo forming. Alternatively, a large thin resin plate obtained by T-die extrusion may be cut out first and preliminarily provided with a certain curved shape by stamping. First and second resin films are respectively put on upper and lower surfaces of the plate, and then heated to melt a hot-melt adhesive to adhere the films to the surfaces and then cooled to cure. Mold stamping is another process for resin molding. Mold is first opened, keeping one resin film on upper surface of the mold cavity and the other resin film on lower surface of the mold cavity, followed by charging a molten resin material on the lower surface of the mold cavity, i.e., on the other resin film kept on the mold surface, and thereafter the mold is closed and pressed to give a shape to the resin material with the films on both sides. Thus, a resin molded product including a resin base member whose both surfaces are covered with resin films. The thus obtained resin molded product is prevented from residual strain and low in deflection (such as inward warp), and it is excellent in productivity with good appearance.

### Industrial Applicability

The present invention can be applied not only to vehicle windows such as automotive vehicle windows but also to various transparent resin molded product such as building windows, lenses, transparent covers and lamp covers.

### Explanation of Reference Numerals

10 Resin Molded Product
12 Front Surface constituting First Main Surface
13 Back Surface constituting Second Main Surface
14, 15 Resin Film
R Molten Resin

What is claimed is:

1. A curved resin molded product comprising:
a pair of resin films defining first and second main surfaces, the first and second main surfaces being different in curvature from each other; and
a resin base member disposed between the resin films,
wherein one of the resin films, which is on the side of a relatively larger curvature of the first and second main surfaces, has a thermal shrinkage larger than that of the other of the resin films which is on the side of a relatively smaller curvature.

2. A curved resin molded product as claimed in claim 1, wherein the difference in thermal shrinkage between the resin films is brought about by the thicknesses of the resin films.

3. A curved resin molded product as claimed in claim 1, wherein the difference in thermal shrinkage between the resin films is brought about by the materials of the resin films.
